(19) United States
(12) Patent Application Publication
(10) Pub. No.: US 2010/0293792 A1
(43) Pub. Date: Nov. 25, 2010

(54) Ergonomic Shears

(76) Inventor: Takuya Ishida, Laguna Niguel, CA (US)

Correspondence Address: CROCKETT & CROCKETT, P.C., 26020 ACERO, SUITE 200, MISSION VIEJO, CA, 92691, US

(21) Appl. No.: 12/786,352

(22) Filed: May 24, 2010

Related U.S. Application Data
(63) Continuation-in-part of application No. 12/335,999, filed on Dec. 16, 2008, now abandoned.
Application No. 12/335,999 is a continuation-in-part of application No. 11/303,823, filed on Dec. 15, 2005, now Pat. No. 7,464,474.

(51) Int. Cl. B26B 13/00

(52) U.S. Cl. 30/232

(57) ABSTRACT

Ergonomic shears according to the present disclosure provides variations in finger relief and thumb alignment to accommodate variations in human physiology and an aligning finger handle that aligns the users fingers into a minimum stress position relative to each other and to the thumb. The thumb apparatus provides three degrees of adjustability to optimize the ergonomics and enable the shears to be used in conventional alignment for cutting away from the user and alternate alignment for cutting toward the user.

### RELATED APPLICATIONS

This application is a continuation-in-part of copending U.S. patent application Ser. No. 12/335,999 filed Dec. 16, 2008, which is a continuation-in-part of U.S. patent application Ser. No. 11/303,823 filed Dec. 15, 2005, now U.S. Pat. No. 7,464,474.

### FIELD OF THE INVENTIONS

The inventions described below relate the field of cutting shears, and more specifically to the field of ergonomic shears for one-handed use.

### BACKGROUND OF THE INVENTIONS

Conventional cutting shears for one-handed use are generally one size fits all. This approach may be sufficient for most people who use shears or scissors occasionally. The inexact fit of the shears or scissors with the shape and flexibility of the human hand causes limited problems.

Some portion of the population use shears or scissors in their chosen line of work, and for these people, the lack of exact fit of shears to the human hand is causing serious physical injury.

### SUMMARY

A pair of ergonomic shears according to the present disclosure includes an aligning finger handle that aligns all of the user's fingers into a minimum stress position relative to each other and to the thumb.

In another aspect, ergonomic shears include a thumb apparatus movably engaging the thumb handle and providing adjustability along three axes to accommodate variations in human physiology. The adjustability of the thumb apparatus permits the ergonomic shears to be used for cutting toward a user in addition to conventionally cutting away from a user.

### BRIEF DESCRIPTION OF THE DRAWINGS

FIG. 1 is a side view of conventional shears.

FIG. 2 is a side view of closed ergonomic shears according to the present disclosure.

FIG. 3 is a side view of open ergonomic shears according to the present disclosure.

FIG. 4 is a side view of closed ergonomic shears according to the present disclosure overlaid on the conventional shears of FIG. 1.

FIG. 5 is a side view illustration of the geometry of the closed ergonomic shears of FIG. 2.

FIG. 6 is a side view of the ergonomic shears of FIG. 2 engaged by a user's hand.

FIG. 7 is a side view of the ergonomic shears of FIG. 2 in a standby position in a user's hand.

FIG. 8 is an alternate configuration of an ergonomic shears according to the present disclosure.

FIG. 9A is a pair of ergonomic shears with a three-axis thumb ring.

FIG. 9B is a cross-section view of the ergonomic shears of FIG. 9A taken along B-B.

FIG. 9C is a cross-section view of the thumb assembly of FIG. 9B taken along C-C.

FIG. 10 is a side view of the ergonomic shears of FIG. 9A engaged by a user's hand.

FIG. 11 is an alternate side view of the ergonomic shears of FIG. 9A engaged by a user's hand.

FIG. 12 is side view of the ergonomic shears of FIG. 9A engaged by a user's hand for cutting toward the user.

### DETAILED DESCRIPTION OF THE INVENTIONS

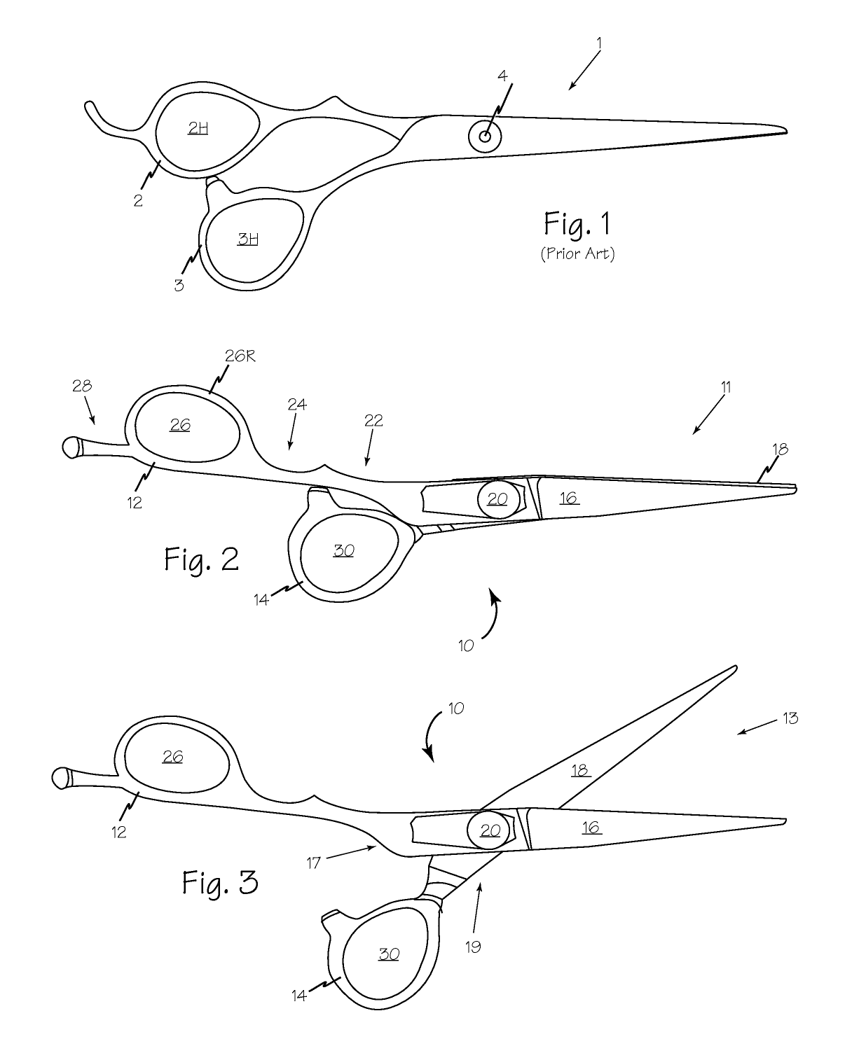

FIG. 1 illustrates conventional shears 1 with finger handle 2 and thumb handle 3 pivoting on pivot 4. The distances from finger hole 2H to pivot 4 is similar to the distance from thumb hole 3H to pivot 4. These distances provide mechanical advantage for cutting thick or heavy material.

FIG. 2 illustrates ergonomic scissors or shears 10 in primary or closed position 11, and FIG. 3 illustrates ergonomic shears 10 in secondary or open position 13. Shears 10 includes handles 12 and 14 connected to blades 16 and 18 respectively which pivot about pivot 20. Finger handle 12 includes finger positions 22, 24, 26 and 28. Third finger position 26 is enclosed by retainer 26R. Thumb handle 14 includes thumb hole 30. Shears 10 surrenders some mechanical advantage by shortening the distance from thumb hole 30 to pivot 20 compared to conventional devices. The benefits are improved ergonomic fit with human hands and minimized thumb movement by shortening the lever arm between the thumb hole and the pivot. Minimal thumb movement results in proportionally large movement of the tip of thumb blade 18.

Finger assembly 17 is formed by the combination of finger handle 12 with finger blade 16. Thumb assembly 19 is formed by the combination of thumb handle 14 with thumb blade 18.

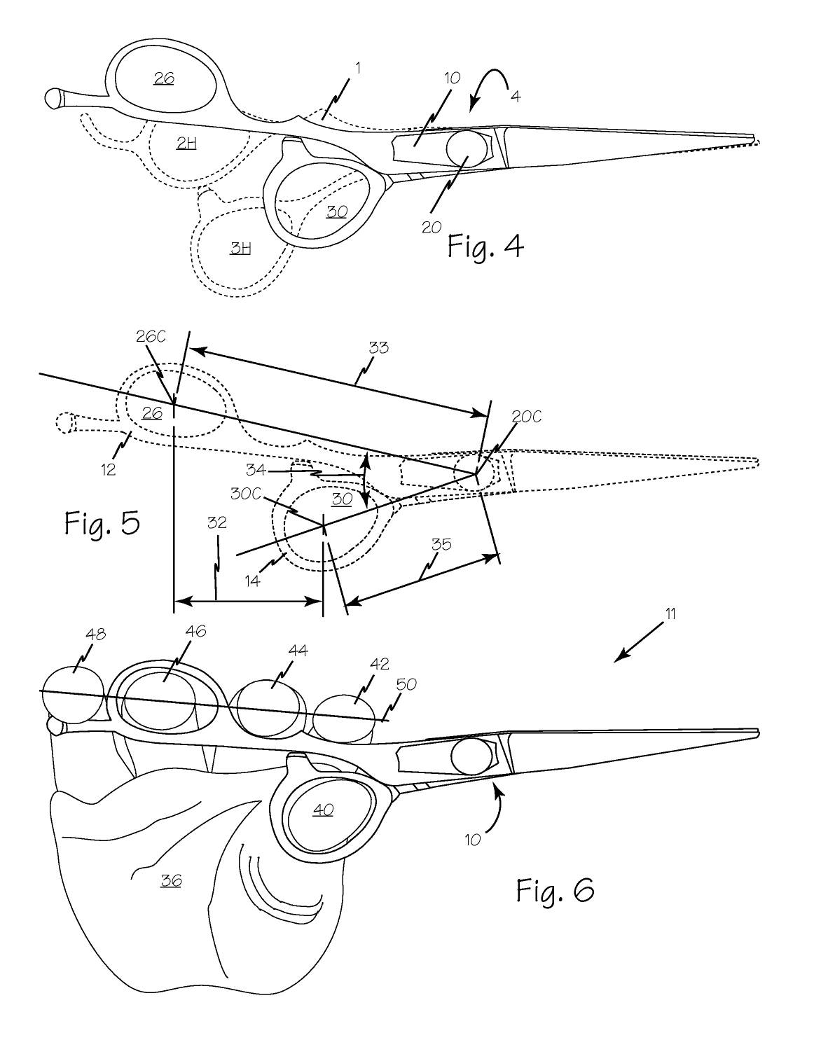

FIG. 4 illustrates a comparison between conventional shears 1 and ergonomic shears 10 with pivot 4 and pivot 20 aligned. Thumb hole 30 of shears 10 is closer to pivot 20 than thumb hole 3H is to pivot 4. Third finger position 26 is slightly farther from pivot 20 than finger hole 2H is from pivot 4. The alignment of third finger position 26 that enables finger positions 22, 24, 26 and 28 to be in a straight line is also illustrated.

Referring now to FIG. 5, the pair of ergonomic shears 10 may be produced in varying sizes and dimensions to minimize stress on a users hand. Finger relief distance 32 is determined in closed position 11 and may be from 1″ to 2¼″ to accommodate variations in human hand dimensions. Handle angle 34 is derived from a straight line from pivot center 20C through thumb hole center 30C and a straight line from pivot center 20C through third finger position center 26C with the shears in closed position 11. Any suitable handle angle 34 may be used with preferred handle angles between 12° and 48°.

Length 33 of finger handle 12 is generally determined by the distance from third finger position 26 to pivot 20. The length 35 of thumb handle 14 may be selected according the material to be cut by shears 10. Heavier material will necessitate lengthening thumb handle 14. The pair of ergonomic shears 10 as illustrated may be suitable for cutting hair or other relatively soft materials. Selection of length 35 to be between ⅓ and ⅔ of length 33 will enable suitable finger relief and produce an ergonomic benefit. The relatively short length 35 enables minimum movement of thumb handle 14 to cause greater movement of thumb blade 18. This advantage will require less movement of the thumb to cut hair or other soft materials thus minimizing stress on a user's hand.

Referring now to FIG. 6, selection of an appropriate finger relief distance 32 and corresponding handle angle 34 will permit a user's hand 36 to engage shears 10 with fingers 42, 44, 46 and 48 aligned along straight line 50. In primary orientation 11, the alignment of fingers 42, 44, 46 and 48 minimizes stress on a user's hand and fingers while maximizing a users control over ergonomic shears 10.

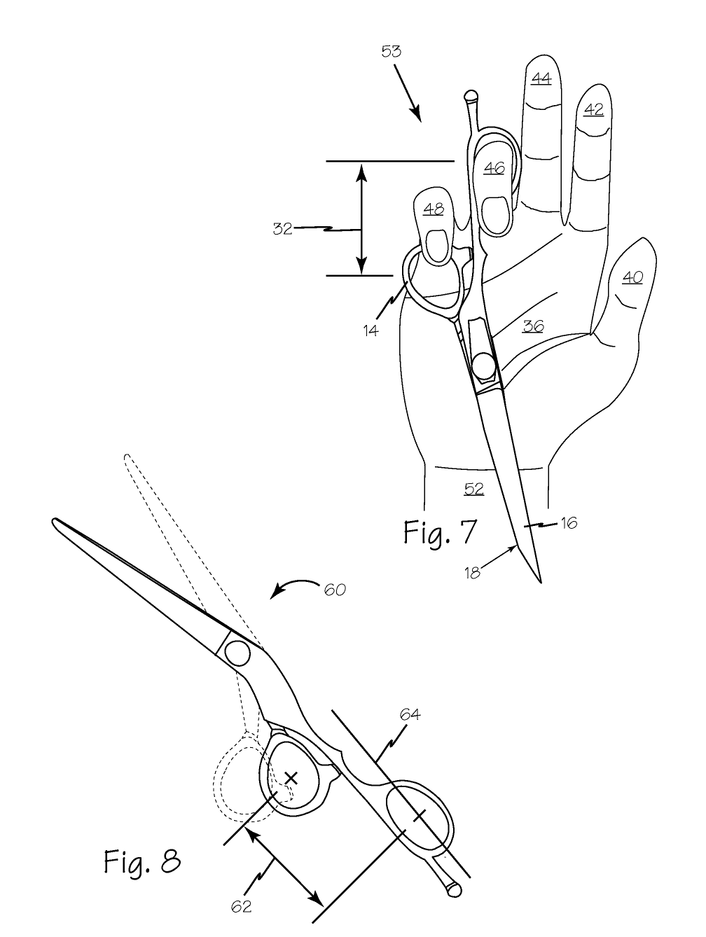

Referring now to FIG. 7, in use a user may permit ergonomic shears 10 to rotate about third finger position 26 allowing the small finger, fourth finger 48, to engage thumb handle 14 as shown. Finger relief distance 32 and the resulting angular separation of third finger position 26 and thumb hole 30 permits blades 16 and 18 to rest along a users wrist 52. Standby orientation 53 frees user's fingers 42, 44 and thumb 40 to be used without the interference and danger posed by ergonomic shears 10.

Alternatively, ergonomic shears according to the present disclosure may adopt any other suitable orientations such as illustrated in FIG. 8. Ergonomic shears 60 maintain a suitable finger relief distance 62 as well as a straight finger alignment 64.

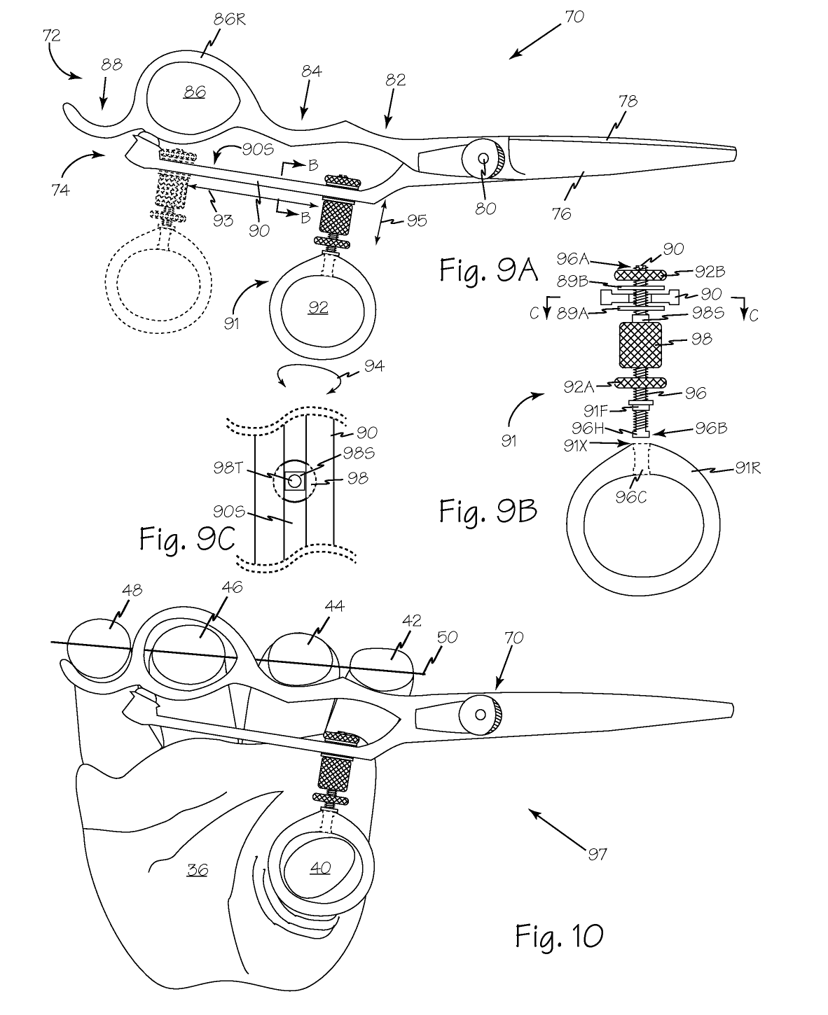

Referring now to FIG. 9A, ergonomic shears 70 include handles 72 and 74 connected to blades 76 and 78 respectively which pivot about pivot 80. Finger handle 72 includes finger positions 82, 84, 86 and 88. Third finger position 86 is enclosed by retainer 86R. Thumb handle 74 includes thumb rail 90 for movably engaging thumb apparatus 91. Thumb rail 90 includes slot 90S to permit thumb apparatus 91 to engage thumb handle 74 along length axis 93. Thumb apparatus 91 may also be adjusted to permit rotation along path 94 and or positioning along extension axis 95.

As illustrated in FIG. 9B, thumb apparatus 91 includes thumb ring 91R engaging threaded shaft 96. Threaded shaft 96 has a first end 96A and a second end 96B. Second end 96B includes head 96H to secure threaded shaft 96 to thumb ring 91R through thumb ring channel 96C along with attachment flange 91F. Attachment flange 91F is welded or other wise secured to thumb ring 91 at opening 91X where threaded shaft 96 extends from thumb ring 91. Attachment flange 91F is not threaded and enables rotation of thumb ring 91R relative to threaded shaft 96. First locking ring 92A is threaded to engage threaded shaft 96 and may be used to secure thumb ring 91R relative to threaded shaft 96 by tightening against flange 91F and creating a tensile force between head 96H and flange 91F. Threaded barrel 98 is threaded to engage threaded shaft 96 and operates in cooperation with second locking ring 92B to control the extension of thumb ring 91R along extension axis 95 and also fixing the position of thumb apparatus 91 along length axis 93. Similarly, permitting a selected level of friction between first and second friction washers 89A, 89B and thumb rail 90 permits thumb apparatus 91 to be moved along length axis 93 with a degree of ease according to the level of friction set by the relative positions of threaded barrel 98 and second locking ring 92B compressing first and second friction washers 89A, 89B respectively to thumb rail 90. The relative positions of threaded barrel 98 and second locking ring 92B also controls the position of threaded shaft 96 relative to thumb rail 90 along extension axis 95.

Shoulder 98S on threaded barrel 98 is generally rectangular and extends into slot 90S to prevent threaded barrel 98 rotating on threaded shaft 96 relative to thumb rail 90 as shown in FIG. 9C. Generally rectangular shoulder 98S surrounds threaded bore 98T.

With second locking ring 92B and threaded barrel 98 threaded to engage threaded shaft 96 and compressing or not first and second friction washers 89A, 89B respectively to thumb rail 90, thumb apparatus 91 may be fixed or move along length axis 93. First and second friction washers 89A, 89B may be made of any suitable material such as metal, or any suitable compressible, flexible material such as PTFE, rubber, fiber or other material. First friction washer 89A may be formed of a first material and the second friction washer 89B may be formed of a second material and the first and second material are different. First locking ring 92A threaded to engage threaded shaft 96 may frictionally engage attachment flange 91F to lock in position or permit rotation of thumb ring 91R along rotation path 94. Additionally, second locking ring 92B and threaded barrel 98 are threaded to engage threaded shaft 96 and compressing or not first and second friction washers 89A, 89B respectively to thumb rail 90, the extension of thumb apparatus 91 may be set along extension axis 95.

During manufacturing, head 96H of threaded shaft 96 is formed with threaded shaft extending through thumb ring channel 96C. During a subsequent manufacturing step, flange 91F is secured to thumb ring 91R at opening 91X. Channel 96C is configured to prevent head 96H from being drawn through channel 96C. Thus, rotating first locking ring 92A to frictionally engage flange 91F puts a portion of threaded shaft 96 between head 96H and first locking ring 92A in tension to frictionally secure thumb ring 91R to threaded shaft 96 in a fixed relationship.

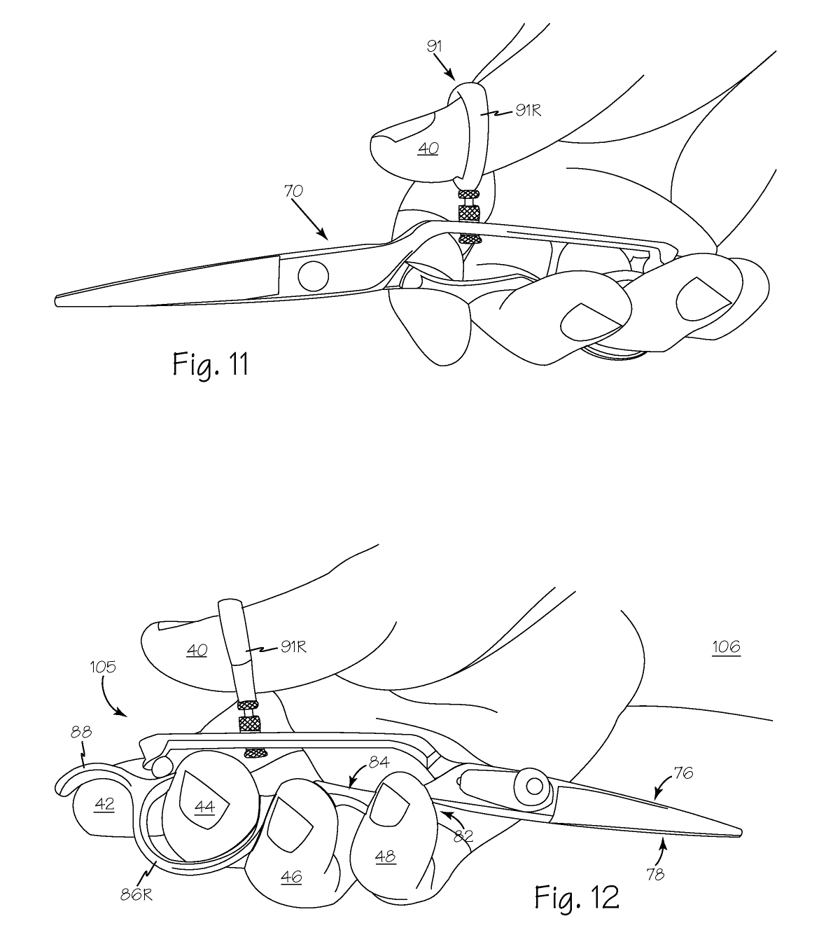

Referring now to FIG. 10, in primary orientation 97, the alignment of fingers 42, 44, 46 and 48 minimizes stress on a user's hand and fingers while maximizing a users control over ergonomic shears 10. In primary orientation 97 a user generally aligns blades 76 and 78 parallel to the users wrist/forearm for cutting away from the user's body. Selection of an appropriate point to secure thumb assembly along length axis 93 and corresponding alignment along extension axis 95 will permit a user's hand 36 to engage ergonomic shears 70 with fingers 42, 44, 46 and 48 aligned along straight line 50.

Referring now to FIG. 11, ergonomic shears 70 are in primary orientation 97 and thumb apparatus 91 is free to pivot allowing thumb 40 to engage thumb ring 91R generally parallel to ergonomic shears 70.

Referring now to FIG. 12, ergonomic shears 70 may be used in alternate orientation 105 and thumb apparatus 91 is free to translate along length axis 93 and pivot allowing thumb 40 to engage thumb ring 91R generally parallel to ergonomic shears 70 with cutting blades 76 and 78 generally parallel to the users forearm 106 with the blades cutting toward the user's body. In alternate orientation 105 finger handle 72 engages fingers 42, 44, 46 and 48 with finger 42 in fourth finger position 88, finger 44 in third finger position 86 engaging ring 86R, finger 46 engaging second finger position 84, and finger 48 engaging first finger position 82.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. Ergonomic shears comprising:
a finger assembly including a finger handle joined to a finger blade, the finger handle having a first, second, third and fourth finger positions, the four finger positions aligned in a straight line with the first, second and fourth finger positions open;
a thumb assembly including a thumb handle joined to a thumb blade, the thumb handle having a thumb rail defining a slot for adjustably engaging a thumb apparatus, the thumb apparatus having a threaded shaft with a first end and a second end, the first end rotatably engaging a thumb ring, the thumb ring for ergonomically engaging a user's thumb, a first locking ring, threaded to engage the threaded shaft to frictionally lock the thumb ring to the threaded shaft and provide rotation control of the thumb ring, a threaded barrel with a generally rectangular shoulder engaging the threaded shaft with the generally rectangular shoulder extending into the thumb rail slot with a first friction washer captured between the threaded barrel and the thumb rail, a second threaded locking ring engaging the threaded shaft near the second end, the second threaded locking ring securing a second friction washer between the second locking ring and the thumb rail to control position along the thumb rail and extension perpendicular to the thumb rail, the position along the thumb rail, the extension perpendicular to the thumb rail and the rotation of the thumb ring relative to the threaded shaft operating independently; and
a pivot joining the finger assembly to the thumb assembly permitting counter rotation of the finger assembly and the thumb assembly about the pivot from a closed position to an open position and from the open position to the closed position.

2. The ergonomic shears of claim 1 wherein the third finger position further comprises a retainer encircling the third finger position, the retainer engaging a user's third finger in a primary orientation and the user's second finger in an alternate orientation.

3. The ergonomic shears of claim 2 wherein the encircled third finger position includes a center, and the thumb apparatus includes a thumb ring surrounding a thumb hole having a center, the distance from the center of the third finger position and the center of the thumb hole is adjustable.

4. The ergonomic shears of claim 1 wherein the first and second friction washers are formed of the same material.

5. The ergonomic shears of claim 1 wherein the first and second friction washers are formed of compressible material.

6. The ergonomic shears of claim 1 wherein the first and second friction washers are formed of PTFE.

7. The ergonomic shears of claim 1 wherein the first friction washer is formed of a first material and the second friction washer is formed of a second material and the first and second material are different.
